(19) United States
(12) Patent Application Publication
(10) Pub. No.: US 2013/0247222 A1
(43) Pub. Date: Sep. 19, 2013

(54) Systems and Methods for Preventing Access to Stored Electronic Data

(71) Applicants: Justin Maksim, Santa Clara, CA (US); Edward Chung, San Jose, CA (US); David Hora, Sunnyvale, CA (US); Michael Lee, San Jose, CA (US); Daniel Maksim, Santa Clara, CA (US); Jeff Rubin, San Francisco, CA (US); Robin Weber, Campbell, CA (US)

(72) Inventors: Justin Maksim, Santa Clara, CA (US); Edward Chung, San Jose, CA (US); David Hora, Sunnyvale, CA (US); Michael Lee, San Jose, CA (US); Daniel Maksim, Santa Clara, CA (US); Jeff Rubin, San Francisco, CA (US); Robin Weber, Campbell, CA (US)

(21) Appl. No.: 13/612,786

(22) Filed: Sep. 12, 2012

Related U.S. Application Data
(60) Provisional application No. 61/535,788, filed on Sep. 16, 2011.

(51) Int. Cl. G06F 21/62; G06F 21/31

(52) U.S. Cl. CPC G06F 21/6218; G06F 21/31
USPC 726/28

(57) ABSTRACT

The techniques described herein include data security systems and methods adapted to protect stored data from unauthorized access. Encryption keys can be maintained on a removable media that allow an authorized user of an agent computing device to access encrypted portions of the removable media. The agent computing device controls access using predefined access control information. An access elimination command communicated to the agent computing device can prevent further access to encrypted data on the removable media.

### CROSS-REFERENCE TO RELATED APPLICATIONS

This application claims priority to U.S. Provisional Patent Application No. 61/535,788, filed on Sep. 16, 2011, which is incorporated herein by reference in its entirety.

### FIELD OF THE INVENTION

Embodiments disclosed herein relate generally to data security and access control. More particularly, the disclosed embodiments relate to remote management of stored data to prevent unauthorized users from accessing sensitive data stored on a lost or stolen computing systems and components.

### BACKGROUND

Electronic information is frequently stored on programmable devices, often on devices that are designed for mobility. The electronic information stored on these programmable devices is therefore susceptible to misappropriation through loss, theft, or unauthorized use of the programmable devices. Commonly used access control methods use, for example, a combination of user identification (“userid”) and a password to allow or disallow users to access the programmable devices. However, userids and passwords provide only limited protection and can be circumvented.

Data encryption is often used as a primary protection technique to conceal electronic information contained in files, packets or other quantities of data. Data encryption uses encryption keys to control the concealment process and the encrypted information is restored only if the encryption keys are available. Encryption cannot guarantee that the concealed data will remain secure because the encryption keys may be discovered by computer driven trial and error processes.

Further, data erasure may leave vestiges of erased files on data storage devices and thus erasure of data may not conceal or protect information. After erasure or overwriting, sophisticated tools may detect variations in storage media that can be used to reconstruct the previously stored data.

This application is related to U.S. patent application Ser. No. 10/897,306, filed on Jul. 21, 2004, now U.S. Pat. No. 7,421,589, U.S. patent application Ser. No. 10/897,964, filed on Jul. 21, 2004, now U.S. Pat. No. 7,543,144, and U.S. patent application Ser. No. 10/897,307, filed on Jul. 21, 2004, now U.S. Pat. No. 7,540,016, all of which are expressly incorporated herein by reference in their entireties.

### SUMMARY

The techniques described herein include a system and a method configured to reduce or eliminate the risk of exposing sensitive electronic information to access by unauthorized users of compromised programmable devices. In at least certain embodiments, this includes identifying compromised programmable device through the detection of loss, theft or attempted unauthorized access of the programmable devices and any sensitive information stored thereon. Further, these techniques can protect owners of sensitive information by providing rapid, targeted destruction of the sensitive information stored on the compromised programmable device thereby reducing the risk that data may be reconstructed after erasure by an unauthorized user.

These embodiments include maintaining one or more encryption keys associated with the removable media for use in authenticating a user of an agent computing device when the removable media is connected to the agent computing device. A key is provided to users to unlock an encrypted portion of the removable media when the user is authenticated. Certain embodiments comprise providing the agent computing device with predefined access control information. An access elimination command can be communicated to the agent computing device upon receiving an access elimination trigger to prevent further access to encrypted portions of the removable media.

In certain embodiments, the agent computing device can be configured to destroy encryption keys maintained on the removable media upon receiving the access elimination command. The agent computing device can also be configured to destroy a partition table of the removable media upon receiving the access elimination command. The access elimination trigger can be initiated by an administrator or by a user of the agent computing device. The access elimination trigger can also be initiated upon determination that a predefined timing interval has elapsed to ensure security of the electronic data stored within a client device even when the client is disconnected from its corresponding server.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, in which:

FIG. 1 depicts an example block diagram representation of one illustrative embodiment;

FIG. 2 depicts an example functional representation of the structure of an client of one illustrative embodiment;

FIG. 3 depicts an example block diagram representation of the relationships between status, rules, events and actions as implemented in certain illustrative embodiments;

FIG. 4 depicts an example representation of the timing protocol governing communications between a central controller and a programmable device of one illustrative embodiment;

FIG. 5 depicts an example flowchart describing an implementation of Overwrite of one illustrative embodiment;

FIG. 6 depicts an example flowchart describing an automatic encryption process of one illustrative embodiment;

FIG. 7 depicts an illustrative embodiment adapted to operate where a firewall is constructed between servers and clients.

### DETAILED DESCRIPTION

For the purposes of explanation, numerous specific details are set forth throughout this description in order to provide a thorough understanding of the techniques described herein. It will be appreciated, however, by persons skilled in the art that these various embodiments may be practiced without some of these specific details. In other instances, well-known structures and devices are shown in block diagram form to avoid obscuring the underlying principles of the embodiments. In at least certain embodiments.

The techniques described herein include a system and a method configured to reduce or eliminate the risk of exposing sensitive electronic information to access by unauthorized users of compromised programmable devices. In at least certain embodiments, this includes identifying compromised programmable device through the detection of loss, theft or attempted unauthorized access of the programmable devices and any sensitive information stored thereon. These techniques can protect owners of sensitive information by providing targeted destruction of the sensitive information stored on the compromised programmable device thereby reducing the risk that data may be reconstructed after erasure by an unauthorized user.

An access elimination command can be communicated to the agent computing device upon receiving an access elimination trigger to prevent further access to encrypted portions of the removable media. In certain embodiments, the agent computing device can be configured to destroy encryption keys maintained on the removable media upon receiving the access elimination command. The agent computing device can also be configured to destroy a partition table of the removable media upon receiving the access elimination command. The access elimination trigger can be initiated by an administrator or by a user of the agent computing device. The access elimination trigger can also be initiated upon determination that a predefined timing interval has elapsed to ensure security of the electronic data stored within a client device even when the client is disconnected from its corresponding server.

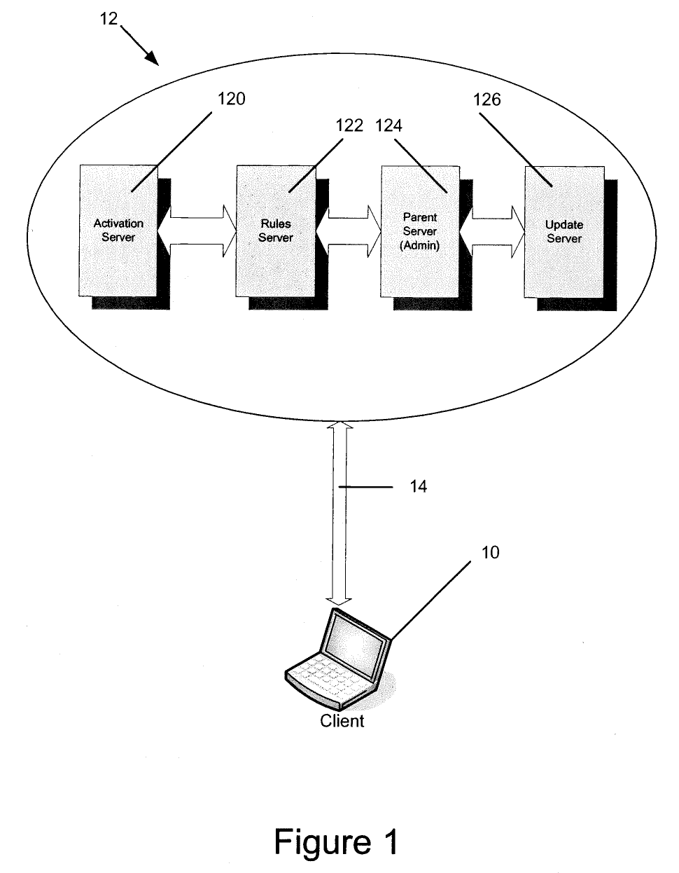

FIG. 1 depicts an example block diagram representation of one illustrative embodiment. The illustrated embodiment of FIG. 1 includes a client 10 and a central controller server 12. As shown, central controller server 12 includes an activation server 120, a rules server 122, a parent server 124, and an update server 126. These various identifications of server 12 as including servers 120-126 are provided solely for purposes of discussion as it is understood by persons of skill in the art that a single physical server or various different physical servers can be used to implement the different functionalities described herein, and that not all of the different servers 120-126 are necessary. The type of server 12, including its various different hardware and software components, as well as the configuration of server or servers, is not of particular significance, and as such many different combinations of hardware and software components can be used to implement the central controller server 12.

Client 10 may be any programmable device such as a desktop computer, laptop computer, handheld computer, Personal Data Assistant (“PDA”), network router, cellular telephone, multimedia entertainment system, network router or switch, or any other similar device that is capable of storing data. A common aspect of the different types of client 10 referred to above is that each client 10 will include a processor of some type that is capable of executing an operating system of some type, and applications thereon, and that electronic data is stored on a memory of some type. In certain embodiments, the client 10 is a computer upon which a Microsoft® Windows XP Professional operating system 220 is installed, and, as such, familiarity with the features of this operating system, including Encrypting File System (EFS), is assumed. Further, the operating system runs with a compatible processor, such as an Intel® processor. Notwithstanding the above, other operating systems and processors may be used. The activation server 120 maintains a set of status information related to the client 10. A typical set of status information is shown below in Table I.

TABLE I

| Date | Time | Status | Event |
|---|---|---|---|
| 20040714 | 08:01:15 | OK | System Boot |
| 20040714 | 09:15:20 | Unable to connect | Connect (60 minutes) |
| 20040714 | 09:30:45 | OK | Lock |
| 20040714 | 09:29:59 | Alert | Invalid Logon |
| 20040714 | 09:45:52 | OK | Unlock |
| 20040714 | 10:45:00 | OK | Connect (60 minutes) |
| 20040714 | 11:45:00 | OK | Connect (60 minutes) |
| 20040714 | 12:45:00 | OK | Connect (60 minutes) |
| 20040714 | 13:15:00 | OK | Shutdown Device |

A system administrator may manually change the contents of the set of status information. For example, when the client 10 is reported lost or stolen, the system administrator may set a “Lost/Stolen” flag in the status information. The set of status information can also be automatically updated by the client 10 when it connects with the activation server 120. The activation server 120 can be configured to transfer a copy of the set of status information to the client 10.

The rules server 122 maintains the set of rules used by the client 10. The set of rules may describe the configuration of the client 10, set decision-making criteria for the client 10, or initiate actions and processes to protect stored data. The set of rules may be modified manually by an administrator or automatically in response to changes in status information received from the client 10. The client 10 periodically communicates with the rules server 122 and the rules server 122 transfers the set of rules or updates to the set of rules to the client 10. A typical rules set, along with a description of each rule, is provided below in Table II.

TABLE II

| | Rule | |
|---|---|---|
| Event Detected | Executed | Description |
| GetRulesSuccess | AutoCrypt | All files residing on the desktop are |
| | (Desktop) | encrypted immediately after the rules |
| | | set is retrieved by the agent |
| Invalid Logon | Shutdown-3 | Agent shutdowns the device on the |
| | | third invalid logon event |
| Invalid Logon | Secure | On the fourth invalid logon event, |
| | Delete | the agent overwrites and deletes the |
| | (Keys)-4 | encryption keys |
| Invalid Logon | Secure | On the fifth invalid logon event, all |
| | Delete | files residing on the desktop are |
| | (Desktop)-5 | overwritten and deleted |
| Invalid Logon | Secure | On the sixth invalid logon, the mail |
| | Delete | database, browser cache, and |
| | (Identity)-6 | passwords stored by the operating |
| | | system are overwritten and deleted |
| Invalid Logon | Delete Files | On the seventh invalid logon, the |
| | (MS Office)-6 | agent deletes all MS Office |
| | | documents residing on the device |
| | | using *.doc, *.xls, *.ppt |
| | Activation | Activation Interval set to 7 days and |
| | Interval | Grace Period set to 15 minutes |

The set of rules and the set of status information are used to select actions to be taken in response to changing circumstances. For example, the agent uses the set of rules to determine actions to taken when “Lost/Stolen” flag indicates that the client 10 has been lost or stolen. The parent server 124 is an administrative server that is used by system administrators to perform tasks such as updating client status, creating and assigning rules, designating user groups containing one or more clients 10, initiating client software updates and generating reports. The parent server 124 may also be used by the system administrators to associate security properties with certain data including definitions such as information type, information size, time sensitivity of the information, and uniqueness of the information and importance of the information. The parent server 124 may also allow the administrators to group similar data into files, directories, or other organizational forms. Data may be similar if, for example, it possesses the same security properties, is located in a common directory, or is in a format used by a common software application such as a word processing application. The update server 126 also distributes software and software updates to the client 10 or to groups of clients as well as to the activation, rules, parent, and update servers.

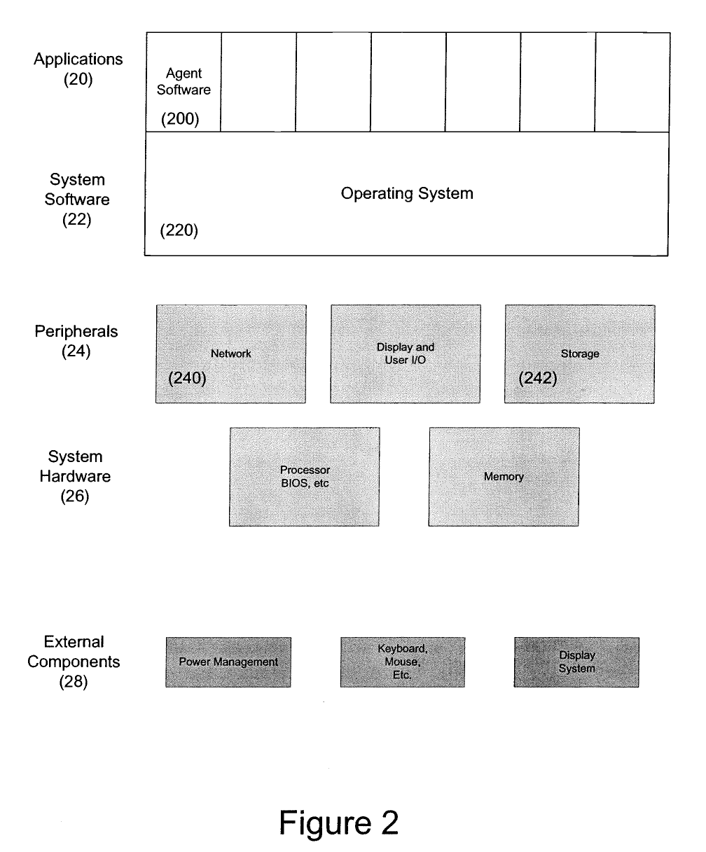

FIG. 2 depicts an example functional representation of the structure of a client 10 according to one illustrative embodiment. As illustrated, client 10 can include a variety of components such as application software 20, system software 22, device specific peripherals 24, hardware components 26 and optional external components 28. It is noted that the memory component of the hardware components 26 can take various forms, including, for example, on-board processor cache memory, RAM (with various types, such as static, dynamic, EDO, DDR, etc. to implement various registers, cache, and other features), ROM, flash memory (particularly used to store BIOS routines). Electronic data stored within memory of the hardware components can be individually accessed through calls made by the operating system, as is known, and familiarity with such requests for such different types of accesses is assumed.

An agent 200 is installed on the client 10. Agent 200 is configured to implement some of the features and functions of the techniques described herein on client 10. In at least certain embodiments, agent 200 is a software application that can be initiated by the operating system 220 when the operating system 220 is loaded or restarted. Agent 200 performs functions using combinations of known operations such as reading and writing directly to components of the client 10, using operating system 220 service calls, or reading and writing operating system 220 registries and data. Various different modules of the agent 200 may be embedded in different system hardware or peripheral components of the client 10, as well as being embedded within the operating system 220. One embodiment includes the capability of the agent 200 to operate independently without direct control of the server 12, the administrator, or the user of the client 10.

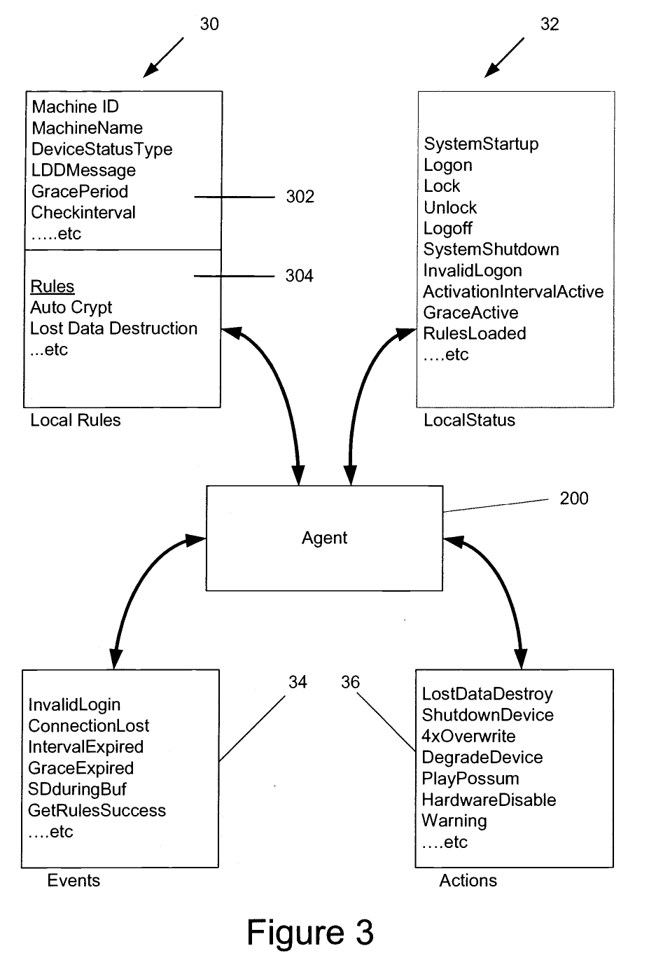

FIG. 3 depicts an example block diagram representation of the relationships between status, rules, events and actions as implemented in certain illustrative embodiments. The operation of the client 10 is directed by configuration information 30 maintained on the client 10. In one embodiment, this information can include system information 302 as well as a local copy of rules 304 (“local rules”) obtained from the rules server 122. The system information 302 can include configuration information of client 10, agent 200, operating system 220, or communications link 14. Table III below illustrates one example of the type of information maintained as configuration information, along with the corresponding descriptions.

TABLE III

| Configuration | |
|---|---|
| Parameter | Description |
| PrimaryServerAddress | Primary IP address for server |
| SecondaryServerAddress | Secondary IP address for server |
| MachineID | Unique alphanumeric machine identifier |
| MachineName | Windows Full computer name |
| DeviceStatus | The status of the device including: OK, |
| | Lost, Stolen, Out-of-Office, Deactivate |
| LDDMessage | The message displayed when the Activation |
| | Interval has expired |
| GracePeriod | The time value (minutes, hours, or days) |
| | for the Grace Period |
| CheckinInterval | A time value, such as 1 hour, which forces |
| | the agent to connect to the server on a |
| | recurring basis |
| ActivationInterval | The time value (minutes, hours, or days) |
| | for the Activation Interval |
| DateCreated | The system date and time for the server, |
| | indicating when the file was created |
| AccountID | The alphanumeric identifier for the user |
| | account |

In addition, Table IV below shows the format of each of the rules that can be stored in the local rules 304. The agent 200 gathers and stores status information 32 (“local status”) describing the state of the client 10. The state may be a set of data containing, for example, a snapshot of information captured from the client 10 related to its activities such as user login and logout, lists of applications running on the client 10, memory capacity, etc.

TABLE IV

| Parameter | Description |
|---|---|
| Trigger | Possible values are Invalid Logon, Auto Encrytion |
| | (“AutoCrypt”), Interval Expired, Grace Period Expired, |
| | etc. |
| TriggerParam | Depends upon the value of the Trigger. |
| Action | Possible values are Delete Files, Overwrite Files, Secure |
| | Delete, etc. |
| ActionParam | Usually file and folder pathnames pertaining to the |
| | Action parameter |
| Active | Boolean value indicating the rule is active or inactive. |
| | Note: Rules remain assigned to the device until removed |
| | by the administrator using the server interface. |
| StartTime | A date/time value indicating the effective (start) date for |
| | the rule. Rules can be preloaded onto a device using this |
| | option and activated without direction from the server. |
| EndTime | A date/time value indication when a rule should be |
| | automatically deactivated by the agent-allows rules to be |
| | automatically deactivated by the agent, without direction |
| | from the server. |
| RuleID | Unique alphanumeric identifier |

Agent 200 may obtain the state information from services provided by a plurality of sources including the activation server 120, rules server 122, parent server 124, update server 126, operating system 220, agent 200, system hardware 26, or the various individual components of the client 10 such as the network interface 240. Agent 200 may also transmit local status information 32 to server 12 when they are connected according to a schedule defined by the configuration information 30. Table V below illustrates a format for storing status information including a notification that a rule has been triggered.

TABLE V

| Parameter | Description |
|---|---|
| AccountID | The alphanumeric identifier for the user |
| | account |
| MachineID | Unique alphanumeric machine identifier |
| RuleID | Unique alphanumeric identifier for the rule |
| | that was triggered |
| System.DateTime.Now | The system date/time for the client when the |
| | rule was triggered |

As shown in FIG. 3, agent 200 generates events 34 and initiates actions 36 based on criteria derived from the configuration information 30 and the local status information 32. The generated events 34 may be used to signal changes in the state of the agent 200 as it executes local rules 304. For example, the agent 200 may generate a timeout event when a timer expires. Actions 36 may be initiated by the agent 200 to perform a variety of functions including data eradication, user validation, data destruction, shutdown, or communications with the server 12 and hardware disablement.

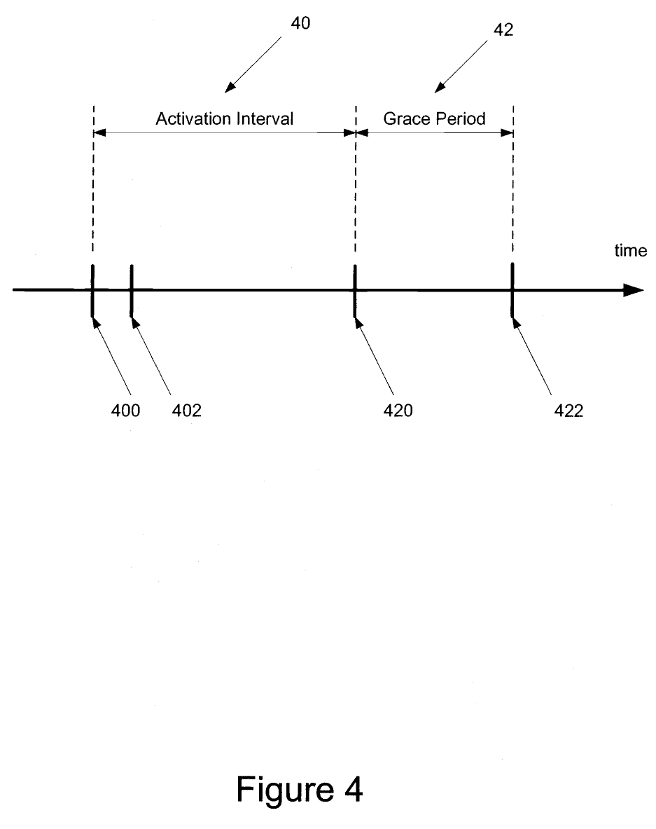

FIG. 4 depicts an example representation of the timing protocol governing communications between a central controller and a programmable device of one illustrative embodiment. A protocol for determining that data has been lost may be understood in context of certain embodiments. In at least certain embodiments, upon establishing a connection with the server 12, the agent 200 initiates transmission of local status information 32 to the parent server 124. The activation server 122 responds by transmitting a current set of status information to the agent 200 to be merged with the local status 32. The rules server 122 also responds by transmitting a current set of rules to the agent 200 to replace the previous version of the local rules 304. In the event the client 10 has been lost or stolen, this information can be communicated to the agent 200 running on the client at the time the client 10 connects with the server over the network. The agent then replaces the previous version of the local rules 304 with a new version.

For cases when the client 10 is disconnected from the server, a time interval is used to maintain security of the data stored on the client device 10. To do this, the agent can initiate a first timer at 400 (“activation timer”) to measure a first time period 40 (“activation interval”) starting from the time the client 10 was most recently connected to server 12. It is understood, however, that while in the preferred embodiment the local set of rules is replaced to initiate the activation interval 40, other manners of initiating the activation interval can be used since it may not be desired to completely replace the local set of rules each time the client 10 connects to the server 12. The agent 200 updates the local status 32, creates at least one event 34 and may initiate actions 36. An event 34 is also created at that time indicating that a successful communication occurred. The activation interval 40 is a measure of time elapsed since the rules were most recently downloaded from the server 12 signifying successful communication with the rules server 122. When the agent 200 is unable to establish a connection with the server 12 within the activation interval, the agent updates status 32 and creates one or more events 34 indicating a loss of connection between the agent 200 and the server 12. The activation interval 40 is determined by the configuration information 30 and can be a real-time measurement that includes the time during which the client 10 is powered off and non-functioning. In some embodiments, the agent 200 warns the user at regular intervals that are less than the activation interval 420 how close the client 10 is to the activation interval 420 elapsing as determined by the configuration information 30. If the client 10 connects to the activation server 120 prior to the elapsing of the activation interval, then the server 12 sends a signal, which can be a reset signal, updated rules, or some other indicator to reset the activation timer to begin a new activation interval. If the client 10 and the activation server 120 remain connected, the signal can then be periodically resent before expiration of the activation interval.

When the time period measured by the activation timer exceeds the activation interval at 420 and the signal is not received by the client 10, the agent 200 may initiate a second timer referred to as a “grace timer” that measures a “grace period” 42 (if the grace period is not set to zero in the configuration information). The grace timer and the activation timer may be reset by a subsequent connection to the server 12. During the grace period, if communication between the client 10 and the server 12 is established, the agent 200 may warn a user that communication with the server 12 has been lost if the activation timer has not yet been reset In some embodiments, the warning may include a prompt to enter a password. If the user enters a correct password, the activation timer can be reset. Further, in some embodiments, the agent 200 warns the user at regular intervals during the grace period that communication between the client 10 and the server 12 has not been established. Communication with the server 12 resets the activation timer and prevents the programmed security features from occurring after the grace period elapses. The grace timer expires after the grace period elapses. The grace timer measures only the time that the client 10 is powered on after the activation interval has expired 420. So if the client has fallen into the hands of an unauthorized user, the grace period will begin once the unauthorized user powers up the client device 10. Otherwise, if the client device 10 has just been left off for an extended period of time, such as while an authorized user is on vacation, the grace timer will not measure time during that time interval in order to avoid a false alarm.

Upon detecting that the grace timer has expired, or detecting that there is no grace period, the agent 120 will update status information 32 and implement the programmed security features based upon the rules, thereby creating events 34 that will initiate a plurality of actions 36 as shown in FIG. 3. These actions 36 can include encryption of data, destruction of operating system registries, destruction of encryption keys, destruction of data, hardware disablement and device shutdown. If the grace period is selected as zero, then immediately after the elapsing of the activation interval, the agent will initiate the programmed events. For certain applications in which security is an overriding concern, the activation interval can be kept running, although the rest of the client 10 is turned off, such that upon the elapsing of the activation interval, other parts of client 10 need to implement the programmed security features are automatically turned on and the programmed security features based upon the rules are initiated. For most applications, however, a grace period will be set in order to allow a user to turn on the client 10 and have a period of time to connect to the server 12 before the initiation of programmed security features that occur upon expiration of the grace period.

In the preferred embodiment, upon the expiration of the grace period the programmed security features will secure data in a prioritized manner such that the most important data is destroyed or encrypted first, and subsequently less important data is destroyed or encrypted. For example, a prioritized destruction of registries, encryption keys or other such information may have the effect of a rapid destruction of large quantities of data by rendering the large quantities of data unreachable or unusable. Further, a system administrator may be able to recover the large quantities of data if the system administrator maintains backup copies of the registries, encryption keys or other such information elsewhere such as on the central controller server 12.

The agent 200 may also determine that the risk of data loss is imminent by detecting invalid access attempts. The agent 200 can detect invalid access attempts by monitoring display messages including login messages and “computer locked” messages. The agent 200 may also detect invalid access attempts by monitoring the operating system 220 security log. Upon each invalid access attempt, the agent 200 can update the local status 32, create one or more events 34, initiate or more actions 36, or send one or more messages to the parent server 124. In some embodiments, the agent 200 may be directed to destroy selected data after a delay, where the delay may be measured by a clock or timer implemented by, for example, system hardware 26 or system software 22.

It will be appreciated that other methods and user behaviors may be used to determining that data is at risk of imminent loss. These behaviors can include, for example: (1) failure to use the proper biometric information, e.g., finger, facial, signature, voice; (2) failure to use a valid token; (3) failure to login effectively with multiple attempts at passwords or from biometrics, tokens or any non-typed entry; (4) attempts to log-in as an unauthorized user on a device; (5) behaviors that are inconsistent with anticipated norms (e.g., attempts to visit restricted web sites); (6) failed password attempts or failed server access attempts; (7) unanticipated changes in hardware or software configuration (e.g., disablement of an existing functionality such as security software, GPS, a communication card or some other PC card or motherboard capability, or enablement of a new software or hardware element such as registry settings, PC card or a port hook-up to an unknown device); or (8) calls, warnings or error messages from the operating system 220 or third party software indicating attempts to access proprietary software.

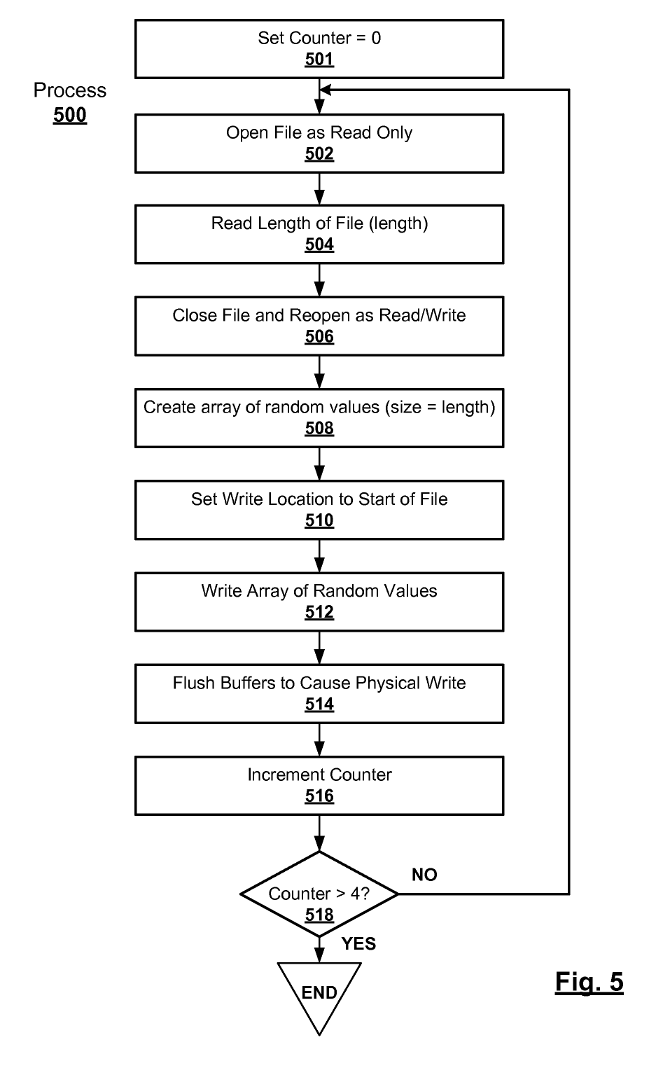

In addition, in order to prevent reconstructing of previously deleted data by an unauthorized user, embodiments use a secure method for erasing data referred to hereinafter as “multiple overwrite.” FIG. 5 depicts an example flowchart describing an implementation of an overwrite process. In the illustration, the multiple overwrite process is performed on a data storage system 242 having one or more data storage devices and a file system. The data storage devices may include fixed magnetic disks, removable magnetic or optical disks, or flash memory as examples. Multiple overwrite can be invoked by the agent 200 according to the local rules 304. The local rules 304 also identify one or more files to be erased by multiple overwrite and specify events 34 that trigger the erasure of the one or more files. Multiple overwrite may be implemented by repeating a series of operations a selected number of times. In one embodiment, the selected number is 4. Criteria for selecting the number of repetitions can include the characteristics of the storage device 242 and the local rules 304.

In the illustrated embodiment, process 500 begins at operation 501 where a counter is initialized to zero and subsequently tested at step 518 thereby forming a loop counter of maximum value 4. Hence, the loop from step 502 until step 518 is executed four times. The multiple overwrite process is an algorithm that includes determining the length of a target file and creating a set of random data and filling the entire target file with the random data. In at least certain embodiments, the agent 200 determines the length of the target file by opening the target file in read-only mode (operation 502) and obtaining the length of the target file (operation 504). The agent then prepares the file for overwrite by closing the target file and subsequently reopening the target file in writeable mode (operation 506). The agent 200 creates a random set of data (operation 508) that is equal in size to the target file and writes it to the target file as shown in operations 510-514. The counter is incremented (operation 516) and tested (operation 518) to determine if four cycles have been completed. Once the data has been overwritten multiple times with random data strings, it becomes much more difficult to reconstruct and recover the data. This completes process 500 according to a preferred embodiment.

At least certain embodiments may disguise data protection operations by deceptively causing activity or non-activity of one or more components of the client. This aspect known hereinafter as “possum mode” can be initiated by the agent based on local rules 304. In certain embodiments, possum mode may be initiated by the agent 200 after the activation interval 40 has expired or after the grace period 42 has expired; or when an invalid login attempt is detected. In possum mode, the agent 200 hides or exposes specific indicators such as power on indicators, hard disk activity indicators, information displayed on display systems, keyboard function indicators, audio indicators and network connectivity indicators. In some embodiments, when possum mode is activated, the agent 200 may permit an intruder to operate the client 10 while the agent 200 is actively destroying data, particularly if the processor on the client supports multiple threads.

At least certain embodiments are also configured to control access to individual components of the client 10 and may prevent unauthorized access to the client using a method herein referred to as “hardware disablement.” Hardware disablement is implemented when the individual components include software that is controllable by the agent 200. Individual components that may have the controllable software include the system hardware 26 (using, for example, modified BIOS), the system software 22, the data storage system 242, or the network interface 240. The agent 200 transmits commands to the controllable software that enable and disable access to hardware components of the client 10, initiate erasure of data stored on individual hardware components, or initiate encryption of data stored on the client's components. The commands may be software or hardware commands or a combination of hardware and software commands as required by the nature of the component receiving the command. For example, one skilled in the art will appreciate that a modified BIOS could be controlled by software commands such as a particular sequence of system calls or extended system calls.

In some embodiments where the data storage system 242 includes disk drives, a version of the agent 200 may be inserted as an “auto-run” agent on the disk drive that can execute when the disk drive is initiated and mounted by the operating system 220. The auto-run agent may execute a copy of the agent if, for example, it detects that no agent is currently installed on the client 10 or the disk drive has been installed as a slave disk drive. The auto-run agent may then initiate actions including lost data destruction, automatic encryption, hardware disablement, or device shutdown to prevent unauthorized users from bypassing the security features through the removal or slaving of disk drives.

### Automatic Encryption

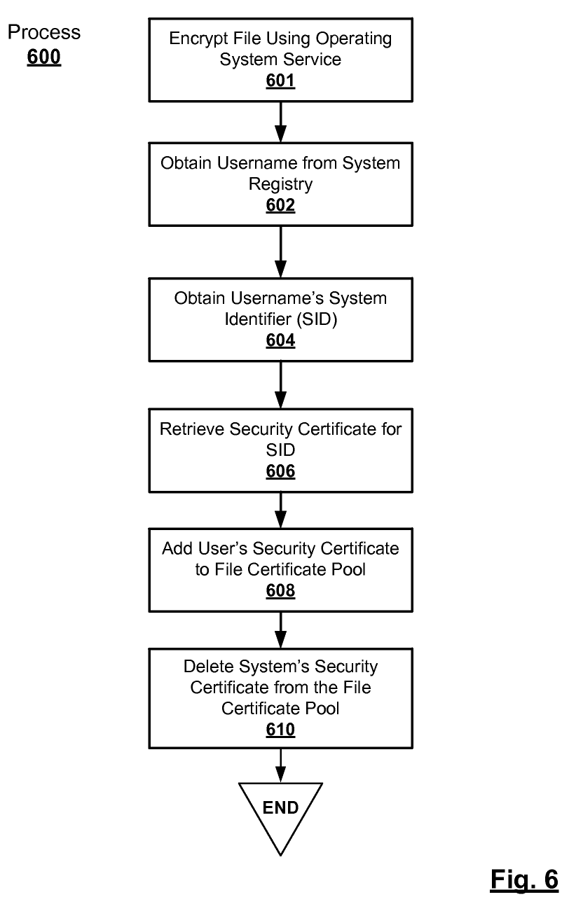

FIG. 6 depicts an example flowchart describing an automatic encryption process of one illustrative embodiment. Automatic encryption of certain files can be performed using Microsoft® Encrypting File System (EFS) or similar such utility depending upon the operating system being used to perform data encryption. Automatic encryption can be performed based upon established encryption rules that will result in automatic encryption events. These encryption rules can be established for all files of a certain type which can be identified by an administrator for all clients 10 that are within a particular organization and can be communicated to the server 12. Once the automatic encryption rule is established or updated, it can be disseminated to the rules set for each different client 10, and then implemented after the rules are downloaded the next time each client 10 connects to the server 12.

Auto-encryption process 600 begins at operation 601 where once a particular client 10 has downloaded the rules set that includes the automatic encryption rules, the agent 200 can initiate one or more system calls to the operating system to cause a selected file to be encrypted. In one embodiment, the files can be encrypted using a system certificate. The agent 200 then searches the operating system's registry for a username identifying the currently logged-in user of the system (operation 602). The agent 200 also obtains a system ID (SID) associated with the username (operation 604). The SID is a unique numerical identifier that may be subsequently used to obtain a related first security certificate at operation 608. The agent 200 then causes the first security certificate to be entered in a pool of security certificates associated with the file thereby providing access to the encryption keys for the current user (operation 608). The agent 200 may delete a second security certificate from the pool where the second security certificate is associated with the operating system's administrator or system user (operation 610).

In at least certain embodiments, real-time encryption can be performed and access to data stored on a computing device, a removable storage media, or other non-transitory storage can be controlled by adapting a file driver that cooperates with an operating system. The file driver can replace or modify existing file management systems to permit an agent to intercept events and other information. For example, the agent may receive notifications of file creation, addition, copy, modification, deletion, etc. The agent may optionally receive notification from file caching systems. Event notifications can be monitored and can initiate encryption of new or modified files on the fly, instead of or in addition to conventional time-based sweeps of the entire storage element. On the fly encryption can comprise real-time encryption, whereby data is encrypted as it is written to non-transitory storage. Real-time encryption may include encryption performed as data is actually written to the storage media. It may also include encryption performed on data stored in cache before it is written to non-volatile storage or may be initiated upon completion of a data write. Real-time encryption can increase system performance by greatly reducing the amount of media or disk input/output required for encryption because storage media scans are typically not required to determine which files need to be encrypted. This completes process 600 according to a preferred embodiment.

### User Encryption using System Certificates

Many operating systems provide user accounts that permit different users to use services and storage on a system or server without sharing or publishing data with other users. Encryption processes and systems deployed on devices that employ such operating systems typically assign user-based certificates to encrypted files. In order to open these encrypted files, applications or processes must be executed by or on behalf of the user associated with the file. Otherwise the file will not be available for lack of permissions. For example, most Windows™ applications follow Microsoft standards that require that the applications run under the account of the current user. Some applications run as a ‘system’ instead of ‘user’. After encryption, these programs are unable to open the files since the user and certificate do not match. A “system” user is typically an administrator who has administrative privileges to the operating system. System users generally have access to all user data on a system. In certain embodiments, an application (referred to as a “credentializer”) can execute any designated processes under a ‘user’ designation instead of ‘system’ designation. This allows processes to open files encrypted with a ‘user’ certificate.

In certain embodiments, certificates can be added to encrypted files so that more than one user can access the file. For example, when a process or task running as ‘system’ attempts to access an encrypted file, an agent may detect the attempt and add the ‘system’ certificate so that the file can be opened. Similarly, certificates can be removed from the encrypted files such that, for example, the “system” certificate can be removed from the encrypted file when the “system” process or task is terminated. Addition and removal of certificates can be performed automatically based upon monitoring of processes, tasks, events, inter-process communications, etc., of the files in play.

Double encryption can also be implemented. In the example of a magnetic disk drive, a first encryption process can manage encryption of an entire disk drive while a second encryption process can encrypt by file or file folder. These first and second processes can be combined, selectively and independently enabled, and configured by an administrator. Disk-level encryption may not offer the level of granularity required to encrypt data according to enterprise policies which can assign access rights by individual, group, or enterprise level. Accordingly, embodiments can be employed to enable both disk-level encryption and file-level encryption. An enterprise administrator may communicate access rights to agents provided on a plurality of mobile computing devices and the agents operate to translate the policies into file level accesses. For example, when an employee of the enterprise assigned to a sales group leaves the enterprise, administrators can remove the former employee from the sales group and that update can be propagated to the agents on the portable computing devices. In this example, the agents can then delete certificates that provided the former employee with access to files restricted to sales group usage. Thus, enterprise policies may be managed remotely through the Internet and using cloud computing services.

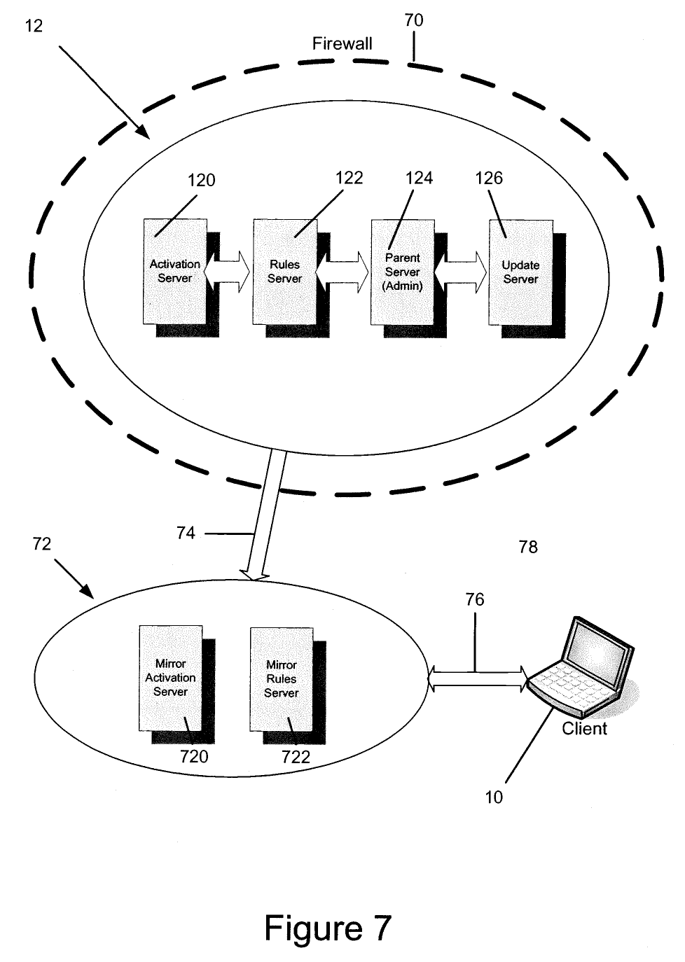

FIG. 7 depicts an illustrative embodiment adapted to operate where a firewall is constructed between servers and clients. The embodiment shown may be used in conjunction with a network firewall 70, in which there exists server 12 located inside the firewall of a particular organization as well one or more mirror servers 72 located outside of the firewall. The network firewall 70 prevents unauthorized access to the server 12 by a client 10 located outside the firewall 70. In order to maintain a degree of control over a client 10 when it is located outside of the firewall, one or more mirror servers 72 can be located outside the firewall 70, where the minor servers 72 are accessible to the client 10 and are configured as copies of the server 12 behind the firewall 70. This allows for communication to implement the setting and re-setting of the activation interval as well as the updating of the local rules set outside the firewall.

The mirror server(s) 72 may include a mirror activation server 720 and a mirror rules server 722. Thus the client 10 can receive rules and status information and a system administrator may modify the status and rules to affect the operation of the client 10. For example, the system administrator may set a Lost/Stolen flag in order to destroy data on a lost or stolen client 10. Accordingly, should there be a subsequent attempt to connect to the mirror server 72, that connection is established so that a rules update can take place to set the Lost/Stolen flag and thereby initiate preprogrammed events, which events may be independent of events relating to the events that occur as a result of the elapsing of the grace period, such as system shutdown.

### Data Access Elimination

In certain embodiments, access to data stored in a device can be eliminated without the need for encryption. Systems can be configured to irrevocably eliminate data access such that data is difficult or impossible to recover through conventional means. Drivers or other software components can be configured on an agent device as well as on one or more network servers to permit bidirectional communication. When triggered, the agent may eliminate the master boot record (“MBR”), including a partition table, an apple partition map (“APM”), guide partition table (“GPT”), or the like, as appropriate for the target system. Elimination of one or more of these tables can make addressing and locating all files and folders extremely difficult using the native operating system or when slaved to another device using a similar operating system. The elimination of partition tables and maps can be triggered by direct command from a server or can be initiated and launched by an action of a user or administrator, typically using a web-based console that may be hosted remotely. Other tools, independent triggers, time-based triggers, and dependent triggers on administrator command may also be used to effect the agent action.

### Data Access Elimination without Agent on Target System

Access to data on removable storage media devices can be prevented through data encryption and other access elimination methods described herein without installation of agent software on the removable storage devices. Software can be deployed on an agent device that can write or read removable media. Software may also be installed on a network server. Communication between server and agent device is typically bidirectional. No custom software or hardware is needed on the removable media. The server software enables remote administration of media policies including, for example, encryption. Specific media identification coupled with user authentication and authorization allows for the locking and unlocking of encrypted data. Each media device is typically provided with a unique identifier that can be based on a serial number of the media device. A network server can capture this information using agent software executed on the agent device. The server may assign a specific encryption key or certificate for each device. A unique user profile may be maintained on a network server for each authorized user. The user profile may include information regarding access rights, including the right to view information on different media or media types. For example, a CEO may be able to view all media, while a junior employee may only view media created by a specific set of users.

Generally, encryption keys assigned to each device may be provided to users who are authorized by the administrator to read or write the data on that device. When a single media device or drive has more than one user writing to it, several keys may be used to segment data on that media device or drive. In certain embodiments, users are restricted to reading those sections of the media device or drive for which they are authorized. An administrator may revoke the rights of any user to read the data at any time. For example, where a terminated employee retains physical access to media belonging to the employer, the terminated employee can be denied access to that data even if the employee was the original author of the material.

The users can carry passwords, which can enable decryption of data on storage media. Passwords can be assigned by the users or administrators. Access using passwords can be granted when the encryption key is carried locally on the agent device or when the user can connect the agent device to the Internet to gain access to the key stored on the server. Generally, the keys and user authentication information are stored on the server, although there is no such specific limitation as other methods are contemplated within the teachings of this disclosure. A “superset” of all possible keys for all users who have logged in previously to the agent device can be stored locally on an agent device. In such an example, users may be required to authenticate to that agent device (i.e., login) to gain access to the keys, before obtaining read or other access to data on any allowable media device connected to that agent device for which the user has permission to read. Typically, this local file of keys is destroyed in a preset (short) period of time, but may be replaced with an updated list from the server when next connected. On example of such usage is for travelers who may have need for the data in circumstances where Internet connection is not possible (e.g., on an airplane or remote locale).

In certain embodiments, media drives can be automatically partitioned to allow users to store encrypted data in a vault, whereby this data can only be accessed on specific agent devices or circumstances (e.g., when connected to the Internet). One or more partitions can be provided to allow non-encrypted data to be written from agent devices that do not contain secure data. For example, a user may bring to work a USB thumb drive storing personal information that was written from a home computer. The user may then connect the drive into a work computer and download encrypted material. These pieces of data will remain separated in their respective vaults. When that user is at work, the user may read from either vault, but can only write to the encrypted vault or volume. On the home computer, the user may read and write only to the unencrypted vault, unless the employer has chosen to allow reading of encrypted material on any device connected to the server or with a proper password.

The foregoing descriptions of the invention are intended to be illustrative and not limiting. Although the present invention has been particularly described with reference to the preferred embodiments thereof, it will be readily apparent to those of ordinary skill in the art that modifications in the form and details of the disclosed embodiments can be made without departing from the spirit and scope of the invention. For example, those skilled in the art will appreciate that the invention can be practiced with various combinations of the functionalities and capabilities described above, and can include fewer or additional components than described above. Certain additional aspects and features can be obtained using the functionalities and components described in more detail above, as will be appreciated by those skilled in the art. Further, embodiments disclosed herein may include various operations as set forth above, or fewer or more operations, or operations in an order different from the order described. Accordingly, the scope of the invention should be judged in terms of the claims which follow as well as the legal equivalents thereof.

What is claimed is:

1. A method of securing data stored on removable electronic storage media comprising:
authenticating a user of an agent computing device when the removable media is connected to the agent computing device, wherein the agent computing device is configured to store predefined access control information;
unlocking an encrypted portion of the removable media using an encryption key provided to the user when the user is authenticated;
identifying when the agent computing device has been compromised through detection of loss, theft, or unauthorized access to the agent computing device; and
communicating an access elimination command to the agent computing device upon receipt of an access elimination trigger, the access elimination command adapted to prevent further access to encrypted portions of the removable media.

2. The method of claim 1, wherein the access elimination trigger is initiated upon receiving status information from a server connected to the agent computing device indicating the agent computing device has been compromised.

3. The method of claim 1, wherein the agent computing device is adapted to encrypt data on the agent computing device upon receiving the access elimination command.

4. The method of claim 1, wherein the agent computing device is adapted to destroy the encryption key upon receiving the access elimination command.

5. The method of claim 1, wherein the agent computing device is adapted perform hardware disablement of one or more components of the agent computing device upon receiving the access elimination command.

6. The method of claim 1, wherein the agent computing device is adapted to perform targeted destruction of data on the agent computing device upon receiving the access elimination command.

7. The method of claim 6, wherein the targeted destruction of data on the agent computing device includes performing a multiple overwrite operation on the data to thwart later reconstruction of the data.

8. The method of claim 6, wherein the agent computing device is adapted to perform targeted destruction of data on the agent computing device after a delay measured by a timer.

9. The method of claim 1, wherein the agent computing device is adapted to destroy a partition table of the removable media upon receiving the access elimination command.

10. The method of claim 1, wherein the access elimination trigger is initiated by an administrator or a user of the agent computing device.

11. The method of claim 1, wherein the access elimination trigger is initiated upon detecting invalid attempts to access the agent computing device.

12. The method of claim 1, wherein the access elimination trigger is initiated upon determination that a predefined activation interval has elapsed.

13. The method of claim 1, further comprising initiating a mode wherein an unauthorized user is permitted to operate the agent computing device while the agent is actively destroying data on the agent computing device.

14. The method of claim 1, wherein real-time encryption is performed as data is written to memory of the agent computing device.

15. The method of claim 1, further comprising performing double encryption of data on the agent communication device including both disk-level and file-level encryption.

16. A system configured to secure data stored on removable electronic storage media, the system comprising:
an authentication module configured to authenticate a user of an agent computing device when the agent computing device is connected to the removable electronic storage media;
a memory to store predefined access control information on the agent computing device; and
an encryption key associated with the user when the user is authenticated to unlock an encrypted portion of the removable media;
a detection module configured to identify when the agent computing device has been compromised through loss, theft, or unauthorized access of the agent computing device; and
a communication module configured to send an access elimination command to the agent computing device upon receipt of an access elimination trigger, the access elimination command adapted to prevent further access to encrypted portions of the removable media.

17. The system of claim 16, wherein the access elimination trigger is initiated upon receiving status information from a server connected to the agent computing device indicating the agent computing device has been compromised.

18. The system of claim 16, wherein the agent computing device is adapted to encrypt data on the agent computing device upon receiving the access elimination command.

19. The system of claim 16, wherein the agent computing device is adapted to destroy the encryption key upon receiving the access elimination command.

20. The system of claim 16, wherein the agent computing device is adapted perform hardware disablement of one or more components of the agent computing device upon receiving the access elimination command.

21. The system of claim 16, wherein the agent computing device is adapted to perform targeted destruction of data on the agent computing device upon receiving the access elimination command.

22. The system of claim 21, wherein the targeted destruction of data on the agent computing device includes performing a multiple overwrite operation on the data to thwart later reconstruction of the data.

23. The system of claim 21, wherein the agent computing device is adapted to perform targeted destruction of data on the agent computing device after a delay measured by a timer.

24. The system of claim 16, wherein the agent computing device is adapted to destroy a partition table of the removable media upon receiving the access elimination command.

25. The system of claim 16, wherein the access elimination trigger is initiated by an administrator or a user of the agent computing device.

26. The system of claim 16, wherein the access elimination trigger is initiated upon detecting invalid attempts to access the agent computing device.

27. The system of claim 16, wherein the access elimination trigger is initiated upon determination that a predefined activation interval has elapsed.

28. The system of claim 16, further comprising initiating a mode wherein an unauthorized user is permitted to operate the agent computing device while the agent is actively destroying data on the agent computing device.

29. The system of claim 16, wherein real-time encryption is performed as data is written to memory of the agent computing device.

30. The system of claim 16, further comprising performing double encryption of data on the agent communication device including both disk-level and file-level encryption.
